(19) United States
(12) Patent Application Publication
(10) Pub. No.: US 2015/0199312 A1
(43) Pub. Date: Jul. 16, 2015

(54) SYSTEM AND METHOD TO SHARE A WEB THREAD DURING PAGE TRANSITIONS IN A WEB BROWSER

(71) Applicant: Futurewei Technologies Inc., Plano, TX (US)

(72) Inventors: Li Li, Bridgewater, NJ (US); Zhihong Qiu, Shenzhen (CN); Tao Cai, Shenzhen (CN)

(21) Appl. No.: 14/596,936

(22) Filed: Jan. 14, 2015

Related U.S. Application Data
(60) Provisional application No. 61/927,211, filed on Jan. 14, 2014.

(51) Int. Cl. G06F 17/22; G06F 17/30

(52) U.S. Cl. CPC G06F 17/2247; G06F 17/30905

(57) ABSTRACT

Various disclosed embodiments include methods and apparatus for sharing a SharedWorker thread during page transitions in a Web browser. A method includes generating a SharedWorker in a Web browser of an electronic device, the SharedWorker comprising an anchor page and a target page, where the anchor page and the target page are linked by the SharedWorker, where the target page is configured to share the SharedWorker with the anchor page.

### CROSS-REFERENCE TO RELATED APPLICATIONS

The present application claims priority to U.S. provisional Application No. 61/927,211 filed on Jan. 14, 2014, which is incorporated herein by reference.

### TECHNICAL FIELD

The present disclosure relates generally to sharing a Web thread during page transitions in a Web browser.

### BACKGROUND

HTML5 is a markup language used for structuring and presenting content for the World Wide Web that makes some changes to web technologies for real-time communications. For example, WebSocket is a protocol providing full duplex communications channels over a single Transmission Control Protocol (TCP) connection. WebRTC (Web Real Time Communication) is an open source protocol for establishing media channels between users and provides a browser-to-browser audio, video, and data stream communication mechanism. WebSocket may be used for WebRTC as the call signaling transport protocol. SharedWorker is a mechanism to allow more than one HTML page to access the same thread. SharedWorker allows multiple open pages to share a Web thread, including WebSocket.

To share a WebSocket between two pages from the same origin, both pages must be open at the same time. When users move back and forth between pages from the same origin with WebSocket, the WebSocket is disconnected and reconnected, creating a 4 round-trip time (RTT) (e.g., 3 TCP+1 WebSocket) handshake overhead. In addition, the user may miss notifications pushed by the server during page transitions after the old WebSocket is disconnected and before the new WebSocket is connected. Furthermore, frequent disconnects and connects may generate unnecessary presence updates for connection based presence systems.

Similarly, at least two pages using the same SharedWorker need to be open for the SharedWorker to be active. When a browser transitions to another page, the SharedWorker is released even if the two pages use the same SharedWorker. Some negative consequences of this are that any running thread, e.g., socket connection, image processing, game view rendering, cryptographic computation, etc., is terminated. One solution is to always keep two pages open. However, this solution complicates application logic and wastes memory resources. Another solution is to prevent the page from transitioning, but a drawback to this approach is that it may negatively impact a user experience. Yet another solution is to recreate the thread in the new page. However, this solution may have drawbacks such as slow response time due to reload of saved thread data from disk, while not all states can be saved, e.g., TCP/IP connections, and it may complicate application logic and security.

### SUMMARY

According to one embodiment, there is provided a method for identifying a plurality of pages that share a SharedWorker in a Web browser of an electronic device. The method includes generating a SharedWorker in a Web browser of an electronic device. The SharedWorker comprises an anchor page and a target page, where the anchor page and the target page are linked by the SharedWorker, where the target page is configured to share the SharedWorker with the anchor page. The method may include receiving an indication of a transition from the anchor page to the target page. The method may also include, in response to receiving the indication, transitioning from the anchor page to the target page, where during the transition from the anchor page to the target page, the anchor page and the target page continue to share the SharedWorker. The method may further include rendering the target page.

In another embodiment, there is provided an electronic device for identifying a plurality of pages that share a SharedWorker in a Web browser of an electronic device. The electronic device includes a processor, and memory coupled to the processor including instructions that, when executed by the processor, cause the electronic device to generate a SharedWorker in a Web browser of an electronic device. The SharedWorker comprises an anchor page and a target page, where the anchor page and the target page are linked by the SharedWorker, where the target page is configured to share the SharedWorker with the anchor page. The electronic device may further include instructions that, when executed by the processor, cause the electronic device to: receive an indication of a transition from the anchor page to the target page; in response to receiving the indication, transition from the anchor page to the target page, where during the transition from the anchor page to the target page, the anchor page and the target page continue to share the SharedWorker; and render the target page.

According to yet another embodiment, there is provided a non-transitory computer readable medium embodying a computer program. The computer program includes computer readable program code for generating a SharedWorker in a Web browser of an electronic device. The SharedWorker comprises an anchor page and a target page, where the anchor page and the target page are linked by the SharedWorker, where the target page is configured to share the SharedWorker with the anchor page. The computer program may further include computer readable program code for: receiving an indication of a transition from the anchor page to the target page; in response to receiving the indication, transitioning from the anchor page to the target page, where during the transition from the anchor page to the target page, the anchor page and the target page continue to share the SharedWorker; and rendering the target page.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a flow diagram of a system that keeps a SharedWorker thread active when the anchor page is transitioning to the target page in a forward direction according to one embodiment;

FIG. 2 illustrates a flow diagram of a system that keeps a SharedWorker thread active when the target page is transitioning to a previous anchor page in a reverse direction according to one embodiment;

FIG. 3A is a flow diagram of a system that illustrates new JavaScript constructors provided by this disclosure for SharedWorker that keep a SharedWorker thread active during various page transitions according to one embodiment;

FIG. 3B is a flow diagram of a system that illustrates a data structure that tracks the pages that access a SharedWorker thread during the various page transitions illustrated in FIG. 3A;

FIG. 4 is a flow diagram of a method for identifying a plurality of pages that share a SharedWorker in a Web browser of an electronic device according to one embodiment;

FIG. 5 illustrates a diagram of an illustrative communication system that can share SharedWorker threads during page transitions in a Web browser according to one embodiment; and

FIGS. 6A and 6B illustrate example devices that can implement sharing SharedWorker threads during page transitions in a Web browser according to one embodiment.

### DETAILED DESCRIPTION

Embodiments of the present disclosure modify the JavaScript SharedWorker constructor and implementation in Web browsers to: (1) allow web applications to specify which target pages can share a SharedWorker created on an anchor page (i.e., the current page that creates the thread) during page transitions; (2) provide a mechanism to maintain the SharedWorker during forward page transitions based on (1) above; and (3) provide a mechanism to maintain the SharedWorker during backward page transitions based on (2) above.

According to one embodiment, specifying permitted target pages includes adding a parameter TargetList in the SharedWorker constructor of the anchor page to specify a list of valid target page URIs as follows: var websocket=new SharedWorker(‘some-thread.js’, name, [‘/target’]). A first parameter (i.e., “some-thread.js”) is the name of the JavaScript program that is going to be run inside the thread. A second parameter (i.e., “name”) is the name of the SharedWorker thread. A third parameter (i.e., “[/target]”) is the added TargetList parameter to tell the browser to allow the SharedWorker thread to be shared with a target page identified by URI reference “/target”.

The target page may use the new constructor or a regular constructor to construct a SharedWorker thread as follows: var websocket=new SharedWorker(‘some-thread.js’, name). The first parameter (i.e., “some-thread.js”) is the JavaScript program name to be run within the thread and the second parameter (i.e., “name”) is the name of the SharedWorker thread. By using the same name, the browser knows that these two pages (e.g., the anchor page and the target page) are sharing the thread because they are sharing the same name.

The anchor page may include all target pages from the same origin as follows: var websocket=new SharedWorker(‘some-thread.js’, name, [*]). The asterisk (*) in the TargetList parameter allows all target pages from the same origin as the anchor page to share the thread. It should be noted that the “name” is unique within the same origin pages and as such, pages that are from a different origin are restricted from accessing the shared SharedWorker thread.

The browser checks a TargetList, and removes any URI reference that is not the same origin as the anchor page. After this step, if the TargetList is not empty, the browser will save the TargetList for the SharedWorker name. Otherwise, the browser will ignore the TargetList and construct the SharedWorker using the existing method.

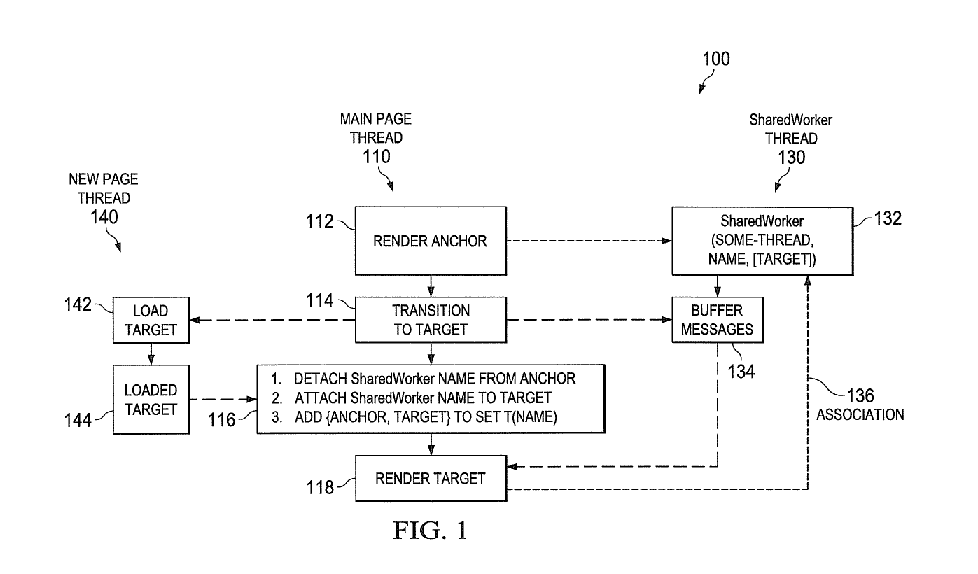

FIG. 1 is a flow diagram of an exemplary embodiment of a system 100 that keeps a SharedWorker thread active when an anchor page is the current page and it is transitioning to a target page in a forward direction (e.g., a forward anchor-target transition). The system 100 includes a main page thread 110 configured to manage activity on the anchor page, a SharedWorker thread 130 configured to execute the SharedWorker object on the anchor page, where the SharedWorker is constructed to be shared with the target page, and a new page thread 140 configured to load the target page.

Referring to the main page thread 110, the anchor page is rendered by the browser, at step 112. In response to a transition event (e.g., a user clicking a link on the anchor page) that causes the anchor page to transition, a transition to the target page occurs where the main page thread 110 launches a new page thread, at step 114. The new page thread 140 begins to load the target page during the transition, at step 142, and after a period of time the transition to the target page is complete when the target page is loaded, at step 144. It will be appreciated that at this point in time, the target page has not yet been rendered or displayed. During this transition period, the main page thread 110 will not release the SharedWorker thread associated with the anchor page when the anchor page is replaced by the target page. Instead, the main page thread 110 creates a message buffer 134 so the SharedWorker thread can continue to execute and save its messages in the buffer.

In response to the target page being loaded at step 144, the main page thread 110 detaches the SharedWorker thread from the anchor page, attaches the SharedWorker thread to the target page that is about to be displayed, and adds anchor and target information (e.g., an {anchor, target} list) to a “T(name)” set, at step 116. The T(name) set represents a data structure that records the pages that access the SharedWorker identified by name. The data structure can be stored in memory or on disk. The data structure combined with the TargetList parameter in the new SharedWorker constructor enforces the security policy by which a SharedWorker thread can only be shared by the pages linked by the TargetList. The set “T(name)” tracks all pages that are allowed to share the particular thread. The target page is rendered at step 118 after detaching the SharedWorker from the anchor page, attaching the SharedWorker to the target page, and adding the {anchor, target} list to the set “T(name)”. The SharedWorker thread continues to execute on the target page without any interruption by the page transition.

During the transition to the target page (step 114), the main thread 110 coordinates buffering of messages that the SharedWorker thread 130 may generate during the transition, at step 134. For example, if the SharedWorker thread 130 is running a WebSocket application, then the message or messages may be associated with the WebSocket application. As another example, if the SharedWorker thread is running an image processing application, then the message or messages may be associated with the image processing application. In response to the target page being loaded at step 144, the messages that are buffered at step 134 are sent to the rendered target page so that the JavaScript programs on the target page can process the messages sent during the transition. In addition, the SharedWorker is associated with the target page at step 136 responsive to the target page being rendered.

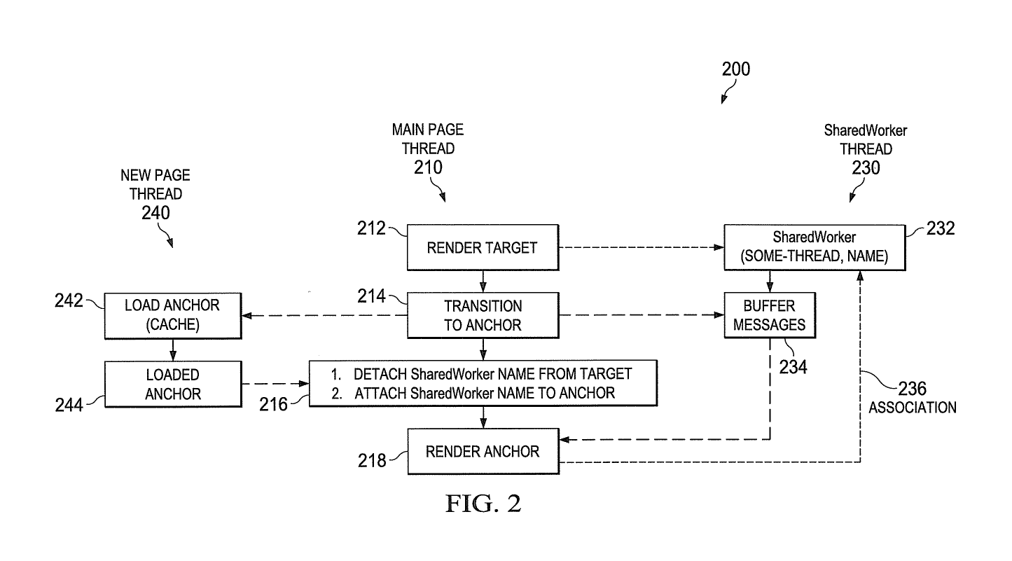

FIG. 2 is a flow diagram of an exemplary embodiment of a system 200 that keeps a SharedWorker thread active when a target page is the current page and it is transitioning back to a previous anchor page in a reverse direction (e.g., a backward target-anchor transition). As the anchor page was recorded in the T(name) for the SharedWorker thread identified by name, this transition is allowed without having to specify the anchor page in the TargetList parameter. The system 200 includes a main page thread 210 configured to manage activity on the target page, a SharedWorker thread 230 configured to execute the SharedWorker object on the target page, where the SharedWorker is shared by the anchor and target pages, and a new page thread 240 configured to load a new page (e.g., a prior or previous anchor page).

Referring to the main page thread 210, the target page is rendered by the browser, at step 212. In response to a transition event (e.g., a user clicking a back button or selecting the target page from the history view) that causes the target page to transition, a transition back to a previous anchor page occurs where the main page thread 210 launches a page loading thread, at step 214. The new page thread 240 begins to load the anchor page, at step 242, and after a period of time the transition to the anchor page is complete when the anchor page is loaded, at step 244. The anchor page may be loaded from the caches or the origin server. It will be appreciated that at this point in time, the anchor page has not yet been displayed. During the transition period, the main page thread 210 will not release the SharedWorker thread associated with the target page when the target page is replaced by the anchor page. Instead, the main page thread 210 creates a message buffer so that the SharedWorker thread can continue to execute and save its messages in the buffer.

In response to the anchor page being loaded at step 244, the main page thread 210 detaches the the SharedWorker thread from the target page, and attaches the SharedWorker thread to the anchor page, at step 216. The anchor page is rendered at step 218 after detaching the SharedWorker thread from the target page, and attaching the SharedWorker thread to the anchor page.

During the transition to the anchor page (step 214), the main page thread 210 coordinates buffering of messages that the SharedWorker thread 230 may generate during the transition, at step 234. For example and as explained above with respect to FIG. 1, if the SharedWorker thread 230 is running a WebSocket application, then the message or messages may be associated with the WebSocket application. As another example, if the SharedWorker thread 230 is running an image processing application, then the message or messages may be associated with the image processing application. In response to the anchor page being loaded at step 244, the messages that are buffered at step 234 are sent to the rendered anchor page so that the JavaScript programs on the anchor page can process the messages sent during the transition. In addition, the SharedWorker is illustrated as being associated with the target page at step 236 responsive to the anchor page being rendered.

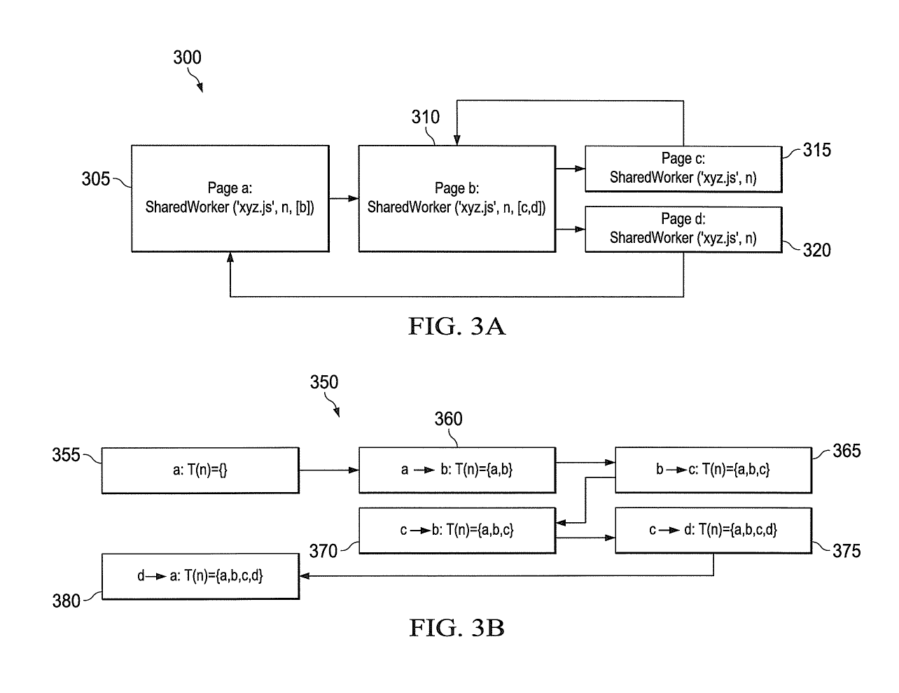

FIG. 3A is a flow diagram of a system 300 that illustrates exemplary uses of the new and original JavaScript constructors for keeping a SharedWorker thread active during various page transitions. The system includes a new JavaScript constructor for page “a” 305, a new JavaScript constructor for page “b” 310, an original JavaScript constructor for page “c” 315, and an original JavaScript constructor for page “d” 320.

The constructor for page “a” 305 illustrates a SharedWorker thread that is going to be shared with another page. In this example, a SharedWorker with the name “n” is going to be shared with target page “b” (e.g., [b]). Assume that page “a” transitions to page “b”. The constructor for page “b” 310 includes another constructor with the same SharedWorker name (i.e., “n”) and including target pages “c” and “d” (i.e., [c, d]). The meaning of the constructor for page “b” 310 is that page “b” is going to share the same thread “n” created on page “a”, and page “b” is going to allow pages “c” and “d” to share that thread. To illustrate, the constructor for page “c” 315 and the constructor for page “d” 320 each include the same SharedWorker name (i.e., “n”) as that included on pages “a” and “b”. However, the original constructors on pages “b” and “c” do not add any target pages for the SharedWorker.

FIG. 3B is a flow diagram of a system 350 that illustrates exemplary tracking data structure T(name) (“T(n)”) during the various page transitions illustrated in FIG. 3A. For example, as illustrated at step 355, when the browser is on page “a”, the constructor T(n) is initially blank or empty (i.e. “{ }”) because the SharedWorker thread “n” has not yet been shared. In response to a transition event occurring (e.g., activating a link on page “a”) that causes a transition from page “a” to page “b”, the data structure T(n) includes “a” and “b” (i.e., “{a, b}”) as illustrated at step 360 because the SharedWorker thread “n” is being shared by pages “a” and “b” and the data structure T(n) tracks the pages that are allowed to share the particular thread.

Because page “b” includes another constructor with the same SharedWorker name (i.e., “n”) and includes target pages “c” and “d” (i.e., [c, d]), in response to a “forward transition” that causes a transition from page “b” to page “c”, (e.g., clicking on a link on page “b”), the data structure T(n) includes “a”, “b”, and “c” (i.e., “{a, b, c}”) as illustrated at step 365 because the SharedWorker thread “n” is being shared by pages “a”, “b”, and “c” and T(n) tracks the pages that are allowed to share the particular thread. If a transition is attempted to a page that is not in the TargetList, the thread will not be shared between those pages.

Step 370 illustrates a “backward transition” that causes a transition from page “c” to page “b” (e.g., by activating a back button or a history view). As illustrated, the data structure T(n) includes “a”, “b”, and “c” and it is the same as in step 365 because the SharedWorker thread “n” is already being shared by pages “a”, “b”, and “c” and T(n) tracks the pages that are allowed to share the particular thread. In response to a “forward transition” that causes a transition from page “b” to page “d” (e.g., clicking on a link on page “b”), the data structure T(n) includes “a”, “c”, and “d” (i.e., “{a, b, c, d}”) as illustrated at step 375 because the SharedWorker thread “n” is being shared by pages “a”, “b”, “c”, and “d” and T(n) tracks the pages that are allowed to share the particular thread.

At step 380, in response to a “backward transition” that causes a transition from page “d” to page “a”, the data structure T(n) includes “a”, “b”, “c”, and “d” and it is the same as in step 375 because the SharedWorker thread “n” is already being shared by pages “a”, “b”, “c”, and “d” and T(n) tracks the pages that are allowed to share the particular thread. If a transition is attempted to a page that is not in the T(n) list, the thread will not be shared between those pages.

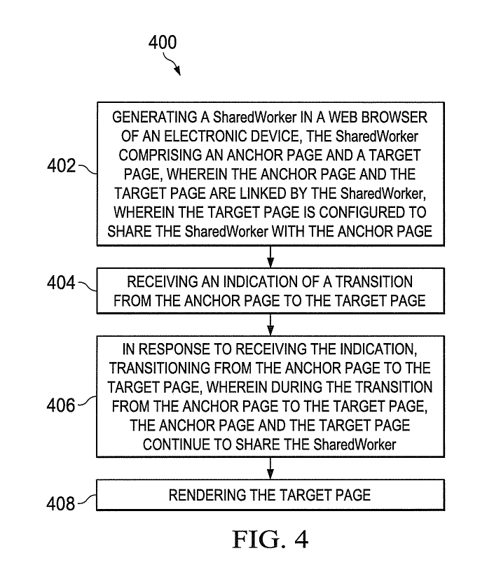

FIG. 4 is a flow diagram of a method 400 for identifying a plurality of pages that share a SharedWorker in a Web browser of an electronic device according to one embodiment. At step 402, a SharedWorker in a Web browser of an electronic device is generated. The SharedWorker comprises an anchor page and a target page, wherein the anchor page and the target page are linked by the SharedWorker, wherein the target page is configured to share the SharedWorker with the anchor page. For example, the anchor page may be page “a” of FIG. 3A, the target page may be page “b” of FIG. 3A, and the constructor for page “a” 305 illustrates a SharedWorker thread that is going to be shared between pages “a” and “b”.

At step 404, an indication of a transition from the anchor page to the target page is received. The anchor page and the target page are linked by a SharedWorker using the new constructor provided by this disclosure. For example, responsive to a transition event (e.g., a user clicking a link on the anchor page) that causes the anchor page to transition, a transition to the target page occurs as illustrated at step 114 of FIG. 1. In addition, a SharedWorker constructor that includes the TargetList parameter is executed, as illustrated at step 132.

At step 406, in response to receiving the indication, a transition from the anchor page to the target page occurs, where during the transition from the anchor page to the target page, the anchor page and the target page continue to share the SharedWorker. For example, the new page thread 140 begins to load the target page during the transition (step 142), and after a period of time the transition to the target page is complete when the target page is loaded (step 144). Thereafter, in response to the target page being loaded, the main page thread 110 detaches the SharedWorker thread from the anchor page, attaches the SharedWorker thread to the target page that is about to be displayed, and adds the {anchor, target} list to the “T(name)” set (step 116).

At step 408, the target page is rendered. For example, after transitioning to and loading the target page, the target page is rendered at the web browser.

FIG. 5 illustrates an example communication system 500 in which a mechanism to share a web thread during page transitions in a Web browser can be implemented. In general, the system 500 enables multiple wireless users to transmit and receive data and other content. The system 500 may implement one or more channel access methods, such as code division multiple access (CDMA), time division multiple access (TDMA), frequency division multiple access (FDMA), orthogonal FDMA (OFDMA), or single-carrier FDMA (SC-FDMA).

In this example, the communication system 500 includes user equipment (UE) 510a-510e, radio access networks (RANs) 520a-520b, a core network 530, a public switched telephone network (PSTN) 540, the Internet 550, and other networks 560, and one or more servers 580. While certain numbers of these components or elements are shown in FIG. 5, any number of these components or elements may be included in the system 500.

The UEs 510a-510e are configured to operate and/or communicate in the system 500. For example, the UEs 510a-510e are configured to transmit and/or receive via wireless or wired communication channels. Each UE 510a-510e represents any suitable end user device and may include such devices (or may be referred to) as a user equipment/device (UE), wireless transmit/receive unit (WTRU), mobile station, fixed or mobile subscriber unit, pager, cellular telephone, personal digital assistant (PDA), smartphone, laptop, computer, touchpad, wireless sensor, or consumer electronics device, all which include and incorporate a browser application.

The RANs 520a-520b here include base stations 570a-570b, respectively. Each base station 570a-570b is configured to wirelessly interface with one or more of the UEs 510a-510c to enable access to the core network 530, the PSTN 540, the Internet 550, and/or the other networks 560. For example, the base stations 570a-570b may include (or be) one or more of several well-known devices, such as a base transceiver station (BTS), a Node-B (NodeB), an evolved NodeB (eNodeB), a Home NodeB, a Home eNodeB, a site controller, an access point (AP), or a wireless router. UEs 510d-510e are configured to interface and communicate with the internet 550 and may access the core network 530, the PSTN 540, and/or the other networks 560, which may include communicating with the server 580.

In the embodiment shown in FIG. 5, the base station 570a forms part of the RAN 520a, which may include other base stations, elements, and/or devices. Also, the base station 570b forms part of the RAN 520b, which may include other base stations, elements, and/or devices. Each base station 570a-570b operates to transmit and/or receive wireless signals within a particular geographic region or area, sometimes referred to as a “cell.” In some embodiments, multiple-input multiple-output (MIMO) technology may be employed having multiple transceivers for each cell.

The base stations 570a-570b communicate with one or more of the UEs 510a-510c over one or more air interfaces 590 using wireless communication links. The air interfaces 590 may utilize any suitable radio access technology.

It is contemplated that the system 500 may use multiple channel access functionality, including such schemes as described above. In particular embodiments, the base stations and UEs implement LTE, LTE-A, and/or LTE-B. Of course, other multiple access schemes and wireless protocols may be utilized.

The RANs 520a-520b are in communication with the core network 530 to provide the UEs 510a-510c with voice, data, application, Voice over Internet Protocol (VoIP), or other services. Understandably, the RANs 520a-520b and/or the core network 530 may be in direct or indirect communication with one or more other RANs (not shown). The core network 530 may also serve as a gateway access for other networks (such as PSTN 540, Internet 550, and other networks 560). In addition, some or all of the UEs 510a-510c may include functionality for communicating with different wireless networks over different wireless links using different wireless technologies and/or protocols. Instead of wireless communication (or in addition thereto), the UEs may communicate via wired communication channels to a service provider or switch (not shown), and to the internet 550.

Although FIG. 5 illustrates one example of a communication system, various changes may be made to FIG. 5. For example, the communication system 500 could include any number of UEs, base stations, networks, or other components in any suitable configuration.

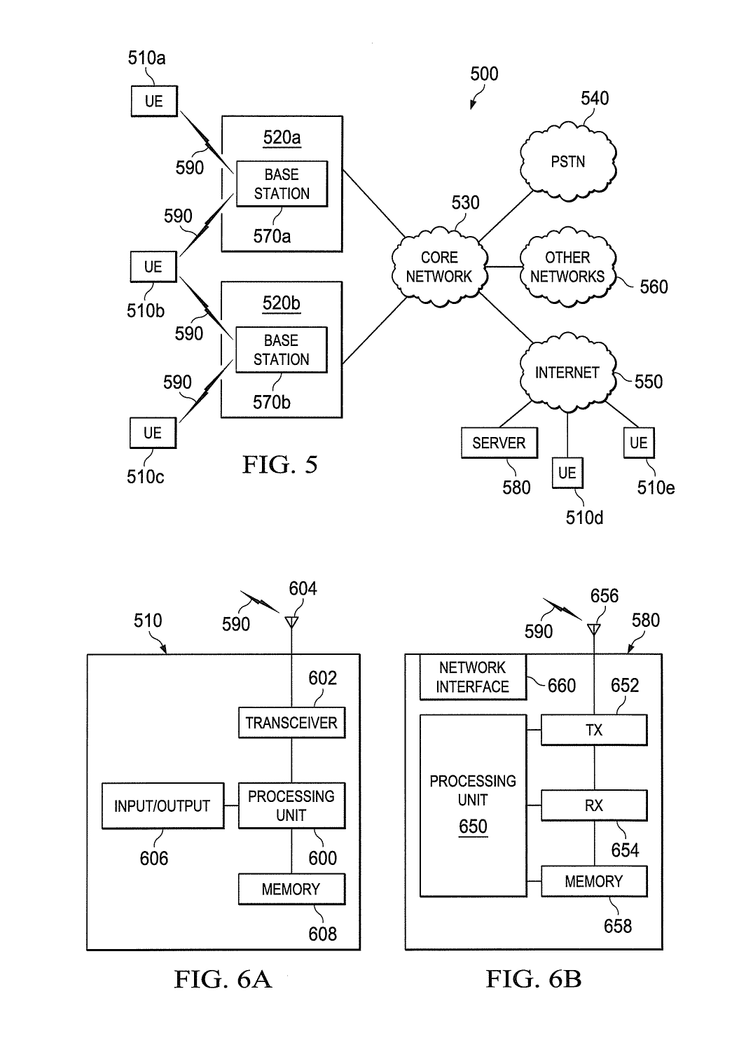

FIGS. 6A and 6B illustrate example devices that may implement the methods and teachings according to this disclosure. In particular, FIG. 6A illustrates an example UE 510, and FIG. 6B illustrates an example server 580. These components could be used in the system 500 or in any other suitable system.

As shown in FIG. 6A, the UE 510 includes at least one processing unit 600. The processing unit 600 implements various processing operations of the UE 510. For example, the processing unit 600 could perform signal coding, data processing, power control, input/output processing, or any other functionality enabling the UE 510 to operate in the system 500. The processing unit 600 also supports the methods and teachings described in more detail above. Each processing unit 600 includes any suitable processing or computing device configured to perform one or more operations. Each processing unit 600 could, for example, include a microprocessor, microcontroller, digital signal processor, field programmable gate array, or application specific integrated circuit.

The UE 510 also includes at least one transceiver 602. The transceiver 602 is configured to modulate data or other content for transmission by at least one antenna 604. The transceiver 602 is also configured to demodulate data or other content received by the at least one antenna 604. Each transceiver 602 includes any suitable structure for generating signals for wireless transmission and/or processing signals received wirelessly. Each antenna 604 includes any suitable structure for transmitting and/or receiving wireless signals. One or multiple transceivers 602 could be used in the UE 510, and one or multiple antennas 604 could be used in the UE 510. Although shown as a single functional unit, a transceiver 602 could also be implemented using at least one transmitter and at least one separate receiver.

The UE 510 further includes one or more input/output devices 606 or interfaces (such as a wired interface to the Internet 550). The input/output devices 606 facilitate interaction with a user or other devices (network communications) in the network. Each input/output device 606 includes any suitable structure for providing information to or receiving/providing information from a user, such as a speaker, microphone, keypad, keyboard, display, or touch screen, including network interface communications.

In addition, the UE 510 includes at least one memory 608. The memory 608 stores instructions and data used, generated, or collected by the UE 510. For example, the memory 608 could store software or firmware instructions executed by the processing unit(s) 600 and data used to reduce or eliminate interference in incoming signals. Each memory 608 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 6B, the server 580 includes at least one processing unit 650, at least one transmitter 652, at least one receiver 654, one or more antennas 656, one or more wired network interfaces 660, and at least one memory 658. The processing unit 650 implements various processing operations of the server 580, such as signal coding, data processing, power control, input/output processing, or any other functionality. The processing unit 650 can also support the methods and teachings described in more detail above. Each processing unit 650 includes any suitable processing or computing device configured to perform one or more operations. Each processing unit 650 could, for example, include a microprocessor, microcontroller, digital signal processor, field programmable gate array, or application specific integrated circuit.

Each transmitter 652 includes any suitable structure for generating signals for wireless transmission to one or more UEs or other devices. Each receiver 654 includes any suitable structure for processing signals received wirelessly from one or more UEs or other devices. Although shown as separate components, at least one transmitter 652 and at least one receiver 654 could be combined into a transceiver. Each antenna 656 includes any suitable structure for transmitting and/or receiving wireless signals. While a common antenna 656 is shown here as being coupled to both the transmitter 652 and the receiver 654, one or more antennas 656 could be coupled to the transmitter(s) 652, and one or more separate antennas 656 could be coupled to the receiver(s) 654. Each memory 658 includes any suitable volatile and/or non-volatile storage and retrieval device(s).

Additional details regarding UEs 510 and server 580 are known to those of skill in the art. As such, these details are omitted here for clarity.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for identifying a plurality of pages that share a SharedWorker in a Web browser of an electronic device, the method comprising:
generating the SharedWorker, the SharedWorker comprising an anchor page and a target page, wherein the anchor page and the target page are linked by the SharedWorker, wherein the target page is configured to share the SharedWorker with the anchor page.

2. The method in accordance with claim 1, further comprising:
receiving an indication of a transition from the anchor page to the target page;
in response to receiving the indication, transitioning from the anchor page to the target page, wherein during the transition from the anchor page to the target page, the anchor page and the target page continue to share the SharedWorker; and
rendering the target page.

3. The method in accordance with claim 2, wherein the SharedWorker includes a SharedWorker constructor executed in the anchor page, the SharedWorker constructor including a parameter configured to specify the target page.

4. The method in accordance with claim 3, wherein the parameter includes a target page uniform resource identifier (URI) reference.

5. The method in accordance with claim 3, wherein transitioning from the anchor page to the target page comprises:
detaching a SharedWorker thread from the anchor page when the target page is loaded;
attaching the SharedWorker thread to the target page; and
storing tracking data associated with anchor page to target page transitions in a memory of the electronic device.

6. The method in accordance with claim 2, further comprising:
buffering a message that the SharedWorker generates during the transition from the anchor page to the target page.

7. The method in accordance with claim 1, wherein the target page comprises a first target page, further comprising:
receiving an indication of a transition from the first target page to a second target page, wherein the first target page and the second target page are linked by the SharedWorker; and
in response to receiving the indication of the transition from the first target page to the second target page, transitioning from the first target page to the second target page, wherein during the transition from the first target page to the second target page, the first target page and the second target page continue to share the SharedWorker.

8. The method in accordance with claim 2, further comprising:
receiving an indication of a transition from the target page to the anchor page, wherein the anchor page and the target page are linked by tracking data to the SharedWorker; and
in response to receiving the indication of the transition from the target page to the anchor page, transitioning from the target page to the anchor page, wherein during the transition from the target page to the anchor page, the target page and the anchor page continue to share the SharedWorker.

9. The method in accordance with claim 8, wherein transitioning from the target page to the anchor page comprises:
detaching a SharedWorker thread from the target page when the anchor page is loaded; and
attaching the SharedWorker thread to the anchor page.

10. The method in accordance with claim 1, wherein the SharedWorker constructor is compliant with a HyperText Markup Language (HTML) and JavaScript.

11. An electronic device for identifying a plurality of pages that share a SharedWorker in a Web browser of the electronic device, comprising:
a processor; and
memory coupled to the processor including instructions that, when executed by the processor, cause the electronic device to:
generate the SharedWorker, the SharedWorker comprising an anchor page and a target page, wherein the anchor page and the target page are linked by the SharedWorker, wherein the target page is configured to share the SharedWorker with the anchor page.

12. The electronic device in accordance with claim 11, further comprising instructions that, when executed by the processor, cause the electronic device to:
receive an indication of a transition from the anchor page to the target page;
in response to receiving the indication, transition from the anchor page to the target page, wherein during the transition from the anchor page to the target page, the anchor page and the target page continue to share the SharedWorker; and
render the target page.

13. The electronic device in accordance with claim 12, wherein the SharedWorker includes a SharedWorker constructor executed in the anchor page, the SharedWorker constructor including a parameter configured to specify the target page.

14. The electronic device in accordance with claim 13, wherein the parameter includes a target page uniform resource identifier (URI) reference.

15. The electronic device in accordance with claim 13, further comprising instructions that, when executed by the processor, cause the electronic device to:
detach a SharedWorker thread from the anchor page when the target page is loaded;
attach the SharedWorker thread to the target page; and
store tracking data associated with anchor page to target page transitions in a memory of the electronic device.

16. The electronic device in accordance with claim 12, further comprising instructions that, when executed by the processor, cause the electronic device to:
buffer a message that the SharedWorker generates during the transition from the anchor page to the target page.

17. The electronic device in accordance with claim 12, wherein the target page comprises a first target page, further comprising instructions that, when executed by the processor, cause the electronic device to:
receive an indication of a transition from the first target page to a second target page, wherein the first target page and the second target page are linked by the SharedWorker; and
in response to receiving the indication of the transition from the first target page to the second target page, transition from the first target page to the second target page, wherein during the transition from the first target page to the second target page, the first target page and the second target page continue to share the SharedWorker.

18. The electronic device in accordance with claim 12, further comprising instructions that, when executed by the processor, cause the electronic device to:
receive an indication of a transition from the target page to the anchor page, wherein the anchor page and the target page are linked to the SharedWorker by tracking data; and
in response to receiving the indication of the transition from the target page to the anchor page, transition from the target page to the anchor page, wherein during the transition from the target page to the anchor page, the target page and the anchor page continue to share the SharedWorker.

19. The electronic device in accordance with claim 18, further comprising instructions that, when executed by the processor, cause the electronic device to:
detach a SharedWorker thread from the target page when the anchor page is loaded; and
attach the SharedWorker thread to the anchor page.

20. A non-transitory computer readable medium embodying a computer program, the computer program comprising computer readable program code for:
generating a SharedWorker in a Web browser of an electronic device, the SharedWorker comprising an anchor page and a target page, wherein the anchor page and the target page are linked by the SharedWorker, wherein the target page is configured to share the SharedWorker with the anchor page.

21. The non-transitory computer readable medium according to claim 20, the computer program further comprising computer readable program code for:
receiving an indication of a transition from the anchor page to the target page;
in response to receiving the indication, transitioning from the anchor page to the target page, wherein during the transition from the anchor page to the target page, the anchor page and the target page continue to share the SharedWorker; and
rendering the target page.

22. The non-transitory computer readable medium according to claim 20, wherein the SharedWorker includes a SharedWorker constructor executed in the anchor page, the SharedWorker constructor including a parameter configured to specify the target page.
